(19) United States
(12) Patent Application Publication
(10) Pub. No.: US 2017/0063452 A1
(43) Pub. Date: Mar. 2, 2017

(54) POWER MONITORING DEVICE AND RECEIVING APPARATUS

(71) Applicant: Mitsubishi Electric Corporation, Chiyoda-ku (JP)

(72) Inventors: Satoshi SHIRAI, Tokyo (JP); Tetsuro ASHIDA, Tokyo (JP); Masamichi NOGAMI, Tokyo (JP)

(73) Assignee: Mitsubishi Electric Corporation, Chiyoda-ku (JP)

(21) Appl. No.: 15/307,979

(22) PCT Filed: Jun. 5, 2014
(86) PCT No.: PCT/JP14/65005

§ 371 Date: Oct. 31, 2016

(51) Int. Cl. H04B 10/079; H04B 10/69

(52) U.S. Cl. CPC H04B 10/07955; H04B 10/69

(57) ABSTRACT

An APD that converts a received optical signal to a current signal, a current mirror circuit that duplicates the current signal and outputs a duplicate current signal as a mirror current, a resistor that converts the mirror current to a voltage, a sample and hold circuit that samples the converted voltage at a timing when a trigger voltage is input and holds a value of the sampled voltage, an inverter connected between the resistor and the sample and hold circuit, and a capacitor connected to the output side of the inverter are included, and the inverter allows the capacitor to be connected to the input side of the sample and hold circuit when a trigger voltage is input to the sample and hold circuit and allows the capacitor to be unconnected to the input side of the sample and hold circuit when the trigger voltage is not input to the sample and hold circuit.

### FIELD

The present invention relates to a power monitoring device and a receiving apparatus.

### BACKGROUND

A receiver for use in optical communication includes a power monitoring circuit for monitoring the power of received light. In a system like a PON (Passive Optical Network), which is used as an access network, a received optical signal is a burst signal. Thus, the power monitoring circuit is required to have quick responsiveness to be able to track a burst signal and high resolution to be able to provide monitoring with high precision even with low reception power.

Conventional power monitoring circuits generally include a current mirror circuit and a sample and hold circuit, as disclosed in Patent Literature 1. In such a reception power monitoring circuit, a current (APD current) proportional to the intensity of an optical signal input to an APD (Avalanche Photo Diode), which is a light receiving element, is input to a current mirror circuit, and the current mirror circuit outputs a mirror current proportional to the APD current. A voltage conversion circuit then converts the mirror current to a voltage. The sample and hold circuit holds a value of the converted voltage and performs AD (Analog to Digital) conversion on the held voltage to obtain a digital value. The power of received light can be monitored by using this digital value.

### CITATION LIST

### Patent Literature

Patent Literature 1: International Publication WO2013/111286

### SUMMARY

### Technical Problem

In the burst optical communication, packets having differing power are multiplexed at shifted times; thus, the receiver is required to receive signals of different power in terms of time. Current proportional to the signal light power flows through the APD as a light receiving element. The power monitoring circuit detects the magnitude of this current to obtain a monitor value. However, when the current mirror circuit cannot respond to a burst signal quickly due to the response speed of an internal transistor or the peripheral capacity, the time required for a mirror current to converge for a transition from signal light having a high power to signal light having a low power is prolonged. This causes an input voltage to the sample and hold circuit to trail.

Signal light is generated such that it has intensities corresponding to data values of “1” and “0,” and is constituted by patterns in which the data values of “1” and “0” are repeated at random. When the current mirror circuit tracks a pattern in which identical data values continue, the mirror current fluctuates to the “1” side and to the “0” side. Hence, a mirror current output from the current mirror circuit is a mirror current fluctuating up and down from a constant current value. In response to the fluctuation of the mirror current, the input voltage to the sample and hold circuit also fluctuates.

Conventional power monitoring circuits have a problem of degradation in monitoring precision due to the fluctuation in the input voltage to a sample and hold circuit in response to a transient response (the trailing) and the fluctuation in the mirror current caused by the tracking of a pattern of data values as described above. To reduce the fluctuation in the mirror current caused by the tracking of a pattern of data values, a capacitor may be added in parallel with a resistor used in the voltage conversion circuit to smooth the output of the voltage conversion circuit and thereby suppress the fluctuation in the input voltage to the sample and hold circuit. The addition of the capacitor, however, slows down the burst response, posing another problem that the convergence time is prolonged.

The present invention has been achieved in view of the above, and an object of the present invention is to provide a power monitoring device and a receiving apparatus capable of improving precision for monitoring the power of received light without reducing the response speed of circuitry.

### Solution to Problem

To solve the above described problem and achieve the object, a power monitoring device according to the present invention includes: a photodetector that converts a received optical signal to a current signal; a current mirror circuit that duplicates the current signal and outputs the duplicated current signal as a mirror current; a current-to-voltage conversion circuit that converts the mirror current to a voltage a sample and hold circuit that samples the voltage resulting from the conversion by the current-to-voltage conversion circuit at a timing when a trigger voltage is input and holds a value of the sampled voltage; a connection switching circuit connected between the current-to-voltage conversion circuit and the sample and hold circuit; and a capacitor connected to an output side of the connection switching circuit. The connection switching circuit allows the capacitor to be connected to an input side of the sample and hold circuit when the trigger voltage is input to the sample and hold circuit and allows the capacitor to be unconnected to the input side of the sample and hold circuit when the trigger voltage is not input to the sample and hold circuit.

### Advantageous Effects of Invention

A power monitoring device and a receiving apparatus according to the present invention achieve an effect of improving precision for monitoring the power of received light without reducing the response speed of circuitry.

### BRIEF DESCRIPTION OF DRAWINGS

FIG. 1 is a diagram illustrating an exemplary configuration of a power monitoring circuit (a power monitoring device) according to a first embodiment of the present invention.

FIG. 2 is a diagram illustrating an example input signal and an example input voltage to a sample and hold circuit in a power monitoring circuit of a comparative example that includes neither a capacitor nor an inverter.

FIG. 3 is a diagram illustrating an example effect of the power monitoring circuit according to the first embodiment.

FIG. 4 is a diagram illustrating an exemplary configuration of a power monitoring circuit according to a second embodiment.

FIG. 5 is a diagram for describing an effect of the second embodiment.

### DESCRIPTION OF EMBODIMENTS

Exemplary embodiments of a power monitoring device and a receiving apparatus according to the present invention will now be described in detail with reference to the drawings. The present invention is not limited by the embodiments.

### First Embodiment

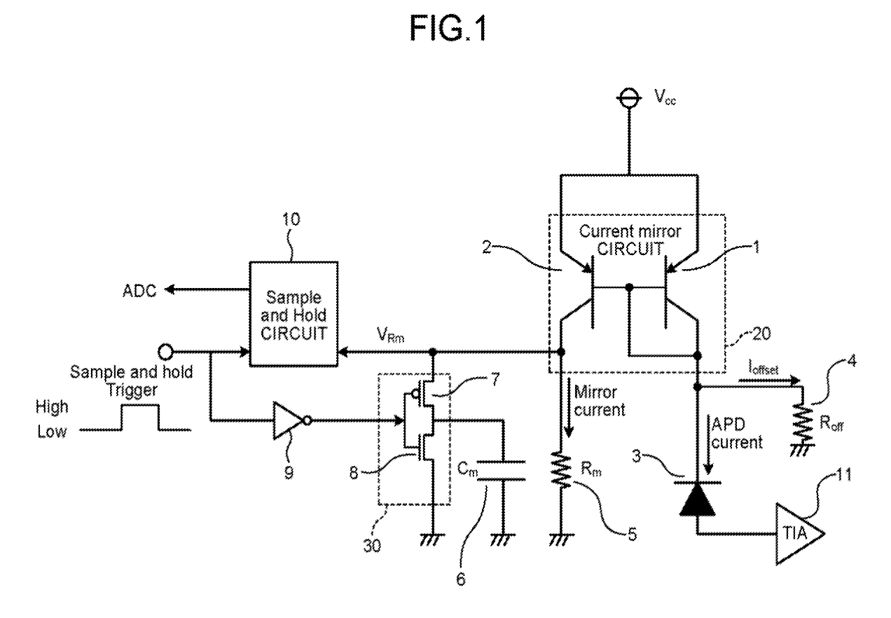

FIG. 1 is a diagram illustrating an exemplary configuration of a power monitoring circuit (a power monitoring device) according to a first embodiment of the present invention. As illustrated in FIG. 1, the power monitoring circuit according to the present embodiment includes a current mirror circuit 20, a sample and hold circuit 10, an APD 3, resistors 4 and 5, a capacitor 6, an inverter 9, a current-to-voltage converter amplifier (TIA) 11, and an inverter 30. The power monitoring circuit according to the present embodiment is mounted in an optical receiver in a receiving apparatus that receives an optical reception signal in, for example, an optical communication system, such as a PON system.

The APD 3 is a photodetector that converts a received optical signal to a current signal. An example is described herein in which the APD is used as a photodetector, although a photodiode other than an APD may be used. The current mirror circuit 20 includes transistors 1 and 2. The transistor 1 and the transistor 2 are mutually connected at their bases. The collector of the transistor 2 is connected to a cathode of the APD 3. The current mirror circuit 20 and the resistor 4 for allowing a constant current to flow through the current mirror circuit 20 constitute a current mirror unit. The current mirror circuit 20 is connected at its output side to: the resistor 5, which is a current-to-voltage conversion circuit for converting a current to a voltage; the inverter 30, which includes a p-type MOS (Metal Oxide Semiconductor) transistor (pMOS) 7 and an n-type MOS transistor (nMOS) 8; the capacitor 6, which is connected to the output of the inverter 30; and the sample and hold circuit 10, to which a voltage obtained by conversion by the resistor 5 is input. A sample and hold trigger signal that indicates the start and end timings of sampling and holding is input to the sample and hold circuit 10. The sample and hold trigger signal is also input to the inverter 9. The inverter 9 inverts the input sample and hold trigger signal and inputs the result to the inverter 30.

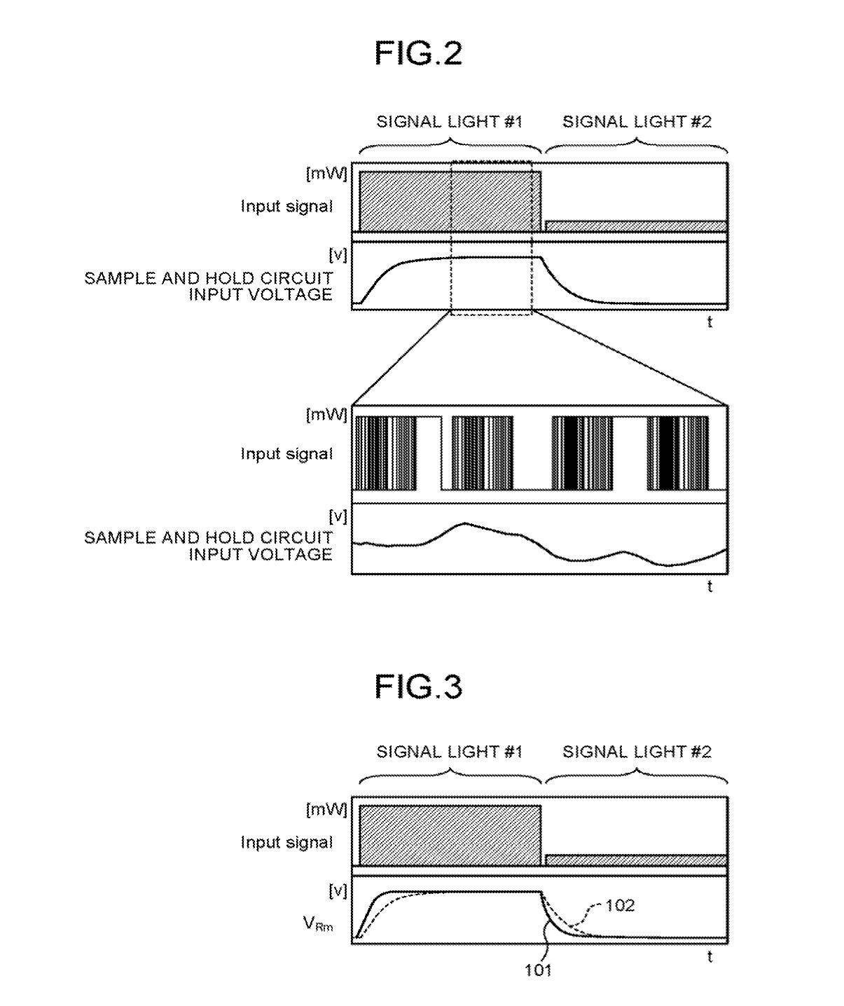

Fluctuation in the monitor value with a power monitoring circuit of a comparative example that includes neither the capacitor 6 nor the inverter 30 will now described. FIG. 2 is a diagram illustrating an example input signal and an example input voltage to the sample and hold circuit in the power monitoring circuit of the comparative example, which incites neither the capacitor 6 nor the inverter 30. In the case where neither the capacitor 6 nor the inverter 30 is included, the current mirror circuit not responding to a burst signal quickly due to the response speeds of the internal transistors or the peripheral capacity prolongs the time taken for the mirror current to converge over a transition from signal light having large power to signal light having small power and, thus, also prolongs the time taken for the input voltage to the sample and hold circuit to converge as illustrated in the input voltage to the sample and hold circuit in the upper graph in FIG. 2.

Furthermore, the signal light is constituted by patterns in which the data values of “1” and “0” are repeated at random. Hence, when the current mirror circuit tracks a pattern in which identical data values continue, the input voltage to the sample and hold circuit also fluctuates as illustrated in the input voltage of the sample and hold circuit in the lower graph in FIG. 2. In the present embodiment, the capacitor 6 and the inverter 30 a re provided in order to improve the precision for monitoring the power of received light without reducing the response speed of the circuitry. This allows a burst signal to be responded quickly upon its input and allows the input voltage to the sample and hold circuit to be smoothed.

The operation of the present embodiment will now be described. A current to be output from the APD 3, which is in proportion to the power of a received optical signal, is duplicated by the current mirror circuit 20 output as a mirror current. The mirror current is converted, by the resistor 5 having a resistance value Rₘ, to a voltage V_{Rm}, and is input to the sample and hold circuit 10. When a sample and hold trigger signal becomes High (when a trigger voltage is input), the sample and hold circuit 10 starts an operation for holding a voltage value of the voltage V_{Rm} to be input. Specifically, for example, the sample and hold circuit 10 starts charging an internal capacitor with electric charge. When the sample and hold trigger signal is turned from High to Low, the sample and hold circuit 10 ends the operation for holding the voltage value of the voltage V_{Rm} to be input and holds the voltage value of the voltage V_{Rm} input when the sample and hold trigger signal is High. In this manner, the sample and hold circuit 10 samples an input voltage and holds it at a timing when the trigger voltage is input. The sample and hold circuit 10 outputs a value of the held voltage to an ADC (an AD converter). The ADC converts the input voltage value to a digital value. This digital value is, for example, input to an arithmetic unit, so that the arithmetic unit can calculate the power of the received optical signal. The resistor 4, which is connected to the current mirror circuit 20 and has a resistance value R_{off}, is a resistor for allowing a constant current to flow through the transistors 1 and 2 of the current mirror circuit 20. The resistor 4 can keep the transistors 1 and 2 operated at all times, thereby allowing for the burst response.

In the present embodiment, the capacitor 6, which smooths voltage fluctuations, is connected to the output side of the inverter 30. When no sample and hold trigger is provided, that is, when the sample and hold trigger signal is Low (when no trigger voltage is input), the pMOS 7 is OFF, and it becomes a state the capacitor 6 is not connected to the input side of the sample and hold circuit 10. Hence, at the moment when a burst signal is input, the current mirror circuit 20 responds quickly without being affected by the capacity of the capacitor 6 and outputs a constant current value in a shortened convergence time. When the sample and hold trigger is input (when the trigger voltage is input), that is, when the sample and hold trigger signal is High, the pMOS 7 is turned ON, and the capacitor 6 is connected to the input side of the sample and hold circuit 10. Thanks to the above described effect the input voltage to the sample and hold circuit 10 is smoothed to provide a smaller fluctuation width.

FIG. 3 is a diagram illustrating an example effect of the power monitoring circuit according to the present embodiment. In FIG. 3, a time response of the input voltage V_{Rm} to the sample and hold circuit 10 is illustrated in the case where an optical signal #1 having large reception power is input to the power monitoring circuit according to the present embodiment, and then, an optical signal light #2 having reception power smaller than that of the optical signal #1 is input. An input voltage 101 indicates the case where the inverter 30 is provided; an input voltage 102 indicates the case where the inverter 30 is not provided (the capacitor 6 is connected to the input side of the sample and hold circuit 10 at all times). As illustrated, use of the inverter 30 allows the input voltage V_{Rm} to be converged quickly even after the receipt of an optical signal having large reception power.

In the example described above, the inverter 30 illustrated in FIG. 1 is used to switch whether or not the capacitor 6 is connected to the input side of the sample and hold circuit 10, however such a connection switching circuit that performs this switching is not limited to the inverter 30 illustrated in FIG. 1. The connection switching circuit may have any circuit configuration as long as it can connect the capacitor 6 to the input side of the sample and hold circuit 10 when a sample and hold trigger is input and disconnect the capacitor 6 from the input side of the sample and hold circuit 10 when no sample and hold trigger is input.

As described above, the capacitor 6, which is connected to the inverter 30, is used in this manner, such that the capacitor 6 is connected to the input side of the sample and hold circuit 10 only when a sample and hold trigger is provided in the present embodiment. This allows a burst signal to be responded quickly and thereby reduces the convergence time and allows the input voltage to be smoothed at the timing of sampling and holding; hence, the monitoring precision is improved.

### Second Embodiment

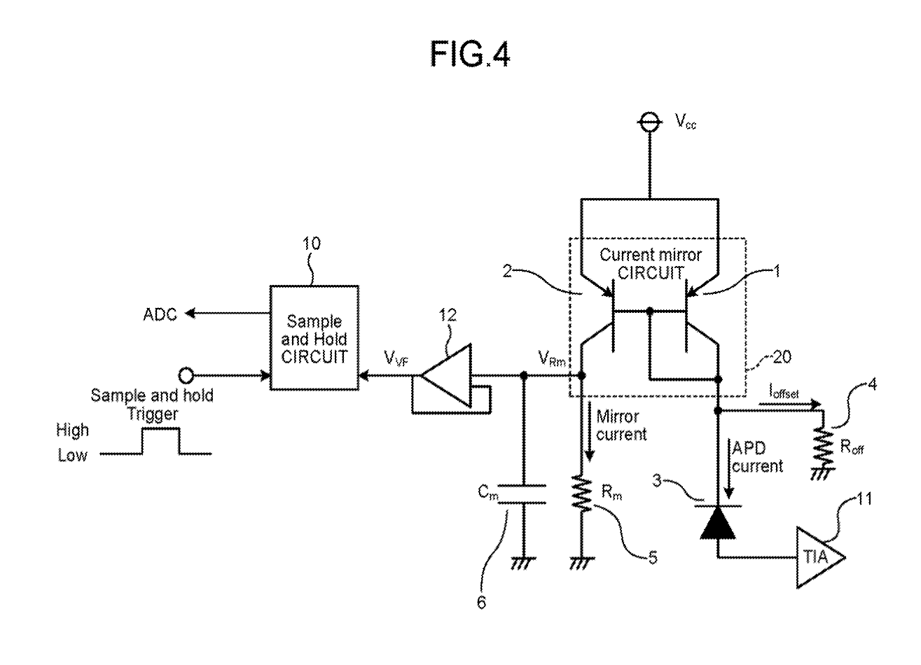

FIG. 4 is a diagram illustrating an exemplary configuration of a power monitoring circuit (a power monitoring device) according to a second embodiment of the present invention. As illustrated in FIG. 4, the power monitoring circuit according to present embodiment includes neither the inverter 30 nor the inverter 9 but includes a voltage follower (a circuit separation unit) 12; otherwise, it has a configuration similar to that of the power monitoring circuit according to the first embodiment. Components having functions similar to those of the first embodiment are designated with identical symbols with those in the first embodiment, and duplicate descriptions are omitted.

In the present embodiment, the capacitor 6 is connected in parallel with the resistor 5 for voltage conversion at all times. The voltage follower 12 is disposed downstream of the resistor 5 and the capacitor 6; the sample and hold circuit 10 is connected downstream of the voltage follower 12.

The operation of the present embodiment will now be described. The operation is similar to that of the first embodiment until a current generated by the APD 3 is converted to a voltage. An object of disposing the voltage follower 12 between the sample and hold circuit 10 and the capacitor 6 is described below. The sample and hold circuit 10 includes an internal capacitor and samples and holds an input voltage by charging the capacitor with electric charge. Thus, a transient response (a non-steady state) is present until electric charge is charged and a constant voltage is held. With the resistor 5 and the capacitor 6 connected to the input side of the sample and hold circuit 10, the time constant is extended due to the resistor 5, the capacitor 6, and the internal capacitor or the sample and hold circuit 10, which prolongs the transient response time. In the present embodiment, the voltage follower 12 is included, such that it disconnects the resistor 5 and the capacitor 6, which are connected to the output side of the current mirror circuit 20, from the sample and hold circuit 10, thereby shortening the time constant and preventing the transient response time from being prolonged. The voltage follower 12 has a very large input impedance and a very small output impedance. Thus, the voltage follower 12 can disconnect an upstream circuit from a downstream circuit.

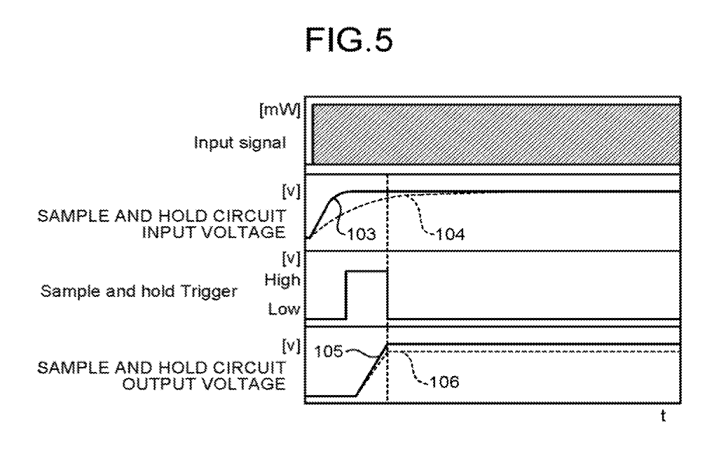

FIG. 5 is a diagram for describing an effect of the present embodiment. Upon input of signal light, an input voltage V_{VP} to the sample and hold circuit 10 rises due to a transient response and then becomes a constant voltage. In FIG. 5, an input voltage 103 is an input voltage to the sample and hold circuit 10 in the case where the voltage follower 12 is present; an input voltage 104 is an input voltage to the sample and hold circuit 10 in the case where the voltage follower 12 is not present. Also in FIG. 5, an output voltage 105 is an output voltage from the sample and hold circuit 10 in the case where the voltage follower 12 is present; an output voltage 106 is an output voltage from the sample and hold circuit 10 in the case where the voltage follower 12 is not present.

The input voltage to the sample and hold circuit 10 differs in rising time depending on whether or not the voltage follower 12 is present; the input voltage rises quickly when the voltage follower 12 is present, and it rises slowly when the voltage follower 12 is not present. With a sample and hold trigger (a trigger voltage) is input at this point of time, the sample and hold circuit 10 operates and holds the input voltage to the sample and hold circuit 10 at the time of falling of the sample and hold trigger. In the case where the trigger width is short, if the voltage follower 12 is not present, the voltage is held in the middle of rising due to a transient response; hence, a voltage value lower than desired voltage value is held. Because of this, a value smaller than that or the reception power that is input as a monitor value is returned, resulting in degradation in monitoring precision.

In contrast, in the case where the voltage follower 12 is present, rising is quick and thus the convergence has been already completed even in a case the trigger width is short and thus returns a desired voltage value, thereby degradation in monitoring precision is prevented. Additionally, the power monitoring circuit according to the present embodiment includes the capacitor 6; hence, it can smooth the input voltage in a similar manner to the first embodiment, thereby improving the monitoring precision.

As described above, the voltage follower 12 is disposed between the sample and hold circuit 10 and the capacitor 6 in the present embodiment. Therefore, the time for a transient response can be shortened, and degradation in monitoring precision can be prevented even with a short trigger width.

### INDUSTRIAL APPLICABILITY

As described above, a power monitoring device and a receiving apparatus according to the present invention are useful for a receiving apparatus that receives an optical signal.

### REFERENCE SIGNS LIST

1 and 2 transistor, 3 APD, 4 and 5 resistor, 6 capacitor, 9 and 30 inverter, 10 sample and hold circuit, 11 TIA, 20 current mirror circuit, 12 voltage follower.

1. A power monitoring device, comprising:
a photodetector that converts a received optical signal to a current signal;
a current mirror circuit that duplicates the current signal and outputs the duplicated current signal as a mirror current;
a current-to-voltage conversion circuit that converts the mirror current to a voltage;
a sample and hold circuit that samples the voltage resulting from the conversion by the current-to-voltage conversion circuit at a timing when a trigger voltage is input and holds a value of the sampled voltage;
a connection switching circuit connected between the current-to-voltage conversion circuit and the sample and hold circuit; and
a capacitor connected to an output side of the connection switching circuit, wherein
the connection switching circuit allows the capacitor to be connected to an input side of the sample and hold circuit when the trigger voltage is input to the sample and hold circuit and allows the capacitor to be unconnected to the input side of the sample and hold circuit when the trigger voltage is not input to the sample and hold circuit.

2. The power monitoring device according to claim 1, wherein the connection switching circuit is an inverter including a p-type MOS transistor and an n-type MOS transistor.

3. (canceled)

4. A receiving apparatus that receives an optical signal, the apparatus comprising:
a photodetector that converts the optical signal to a current signal;
a current mirror circuit that duplicates the current signal and outputs the duplicated current signal as a mirror current;
a current-to-voltage conversion circuit that converts the mirror current to a voltage;
a sample and hold circuit that samples the voltage resulting from the conversion by the current-to-voltage conversion circuit at a timing when a nigger voltage is input and holds a value of the sampled voltage;
a connection switching circuit connected between the current-to-voltage conversion circuit and the sample and hold circuit; and
a capacitor connected to an output side of the connection switching circuit, wherein
the connection switching circuit allows the capacitor to be connected to an input side of the sample and hold circuit when the trigger voltage is input to the sample and hold circuit and allows the capacitor to be unconnected to the input side of the sample and hold circuit when the trigger voltage is not input to the sample and hold circuit.

5. (canceled)
